(19) United States
(12) Patent Application Publication
(10) Pub. No.: US 2021/0407368 A1
(43) Pub. Date: Dec. 30, 2021

(54) DISPLAY DEVICE AND OVERDRIVE METHOD THEREOF

(71) Applicant: TCL CHINA STAR OPTOELECTRONICS TECHNOLOGY CO., LTD., Shenzhen, Guangdong (CN)

(72) Inventor: Xiang GAO, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 16/640,835

(22) PCT Filed: Jan. 10, 2020
(86) PCT No.: PCT/CN2020/071407

§ 371 Date: Feb. 21, 2020

(30) Foreign Application Priority Data
Dec. 31, 2019 (CN) 201911413727.1

(51) Int. Cl. G09G 3/20

(52) U.S. Cl. CPC G09G 3/2074; G09G 2310/0291; G09G 2310/08; G09G 2310/027

(57) ABSTRACT

A display device and an overdrive method thereof are provided. The overdrive method includes that in a frame picture, when a data signal of a data line needs to be switched from a grayscale of a previous row to a target grayscale of a current row, a feedback grayscale is looked up to be obtained according to a default feedback lookup table, the target grayscale of the current row, and an input grayscale of the previous row, a gain grayscale is looked up to be obtained according to a default gain lookup table and the feedback grayscale, and the gain grayscale is stored into a row buffer.

### FIELD OF INVENTION

The present disclosure relates to the field of display technologies, and more particularly, to a display device and an overdrive method thereof.

### BACKGROUND OF INVENTION

With improvement of display resolution, panel sizes of display devices increasing, improvement of charging times for every model, and improvement of resistance-capacitance of panels, charge rate issues are getting significant. Current technology provides liquid crystals with an overdrive (OD) technique to achieve a predetermined deflection goal in a shorter time. The principle of the OD technique is that when a data signal of a data line needs to be switched from a grayscale of a previous row to a target grayscale of a current row, if only the target grayscale of the current row is applied with a drive voltage, due to a slow deflected reaction rate of liquid crystals, the needed target grayscale of the current row actually cannot be achieved. However, the OD technique would provide the target grayscale of the current row with an overdrive voltage that is greater than a drive voltage corresponding to the target grayscale of the current row, thereby speeding up the deflection rate of liquid crystals to obtain the actual needed target grayscale of the current row.

Although current overdrive technique can improve a problem of insufficient charge caused by grayscale hopping, following defects still exist. In current line overdrive technique, when data lines perform grayscale hopping, a target grayscale of a current row is compared to an input grayscale of a previous row, so it would cause sub-pixels of a next row to be overcharged when a grayscale of a current row hops and a grayscale of a next row does not hop. As shown in FIG. 1, a green (G) sub-pixel, a blue (B) sub-pixel, and a red (R) sub-pixel are sub-pixels connected to a same data line and arranged along a column. The G sub-pixel has a grayscale value of 64 when charging, that is, a target grayscale value of a current row is 64. The B sub-pixel has a grayscale value of 0 when charging, that is, an input grayscale value of a previous row is 0. The R sub-pixel has a grayscale value of 64 when charging, that is, a target grayscale value of a next row is 64. When the G sub-pixel is charged, an overdrive grayscale value of the current row is 86 which is looked up to be obtained according to an overdrive lookup table, the target grayscale of the current row, and the input grayscale of the previous row, thereby loading an overdrive voltage corresponding to the grayscale value of 86 to the data line and making an average voltage of charging the G sub-pixel a target voltage U1. When the R sub-pixel of the next row is charged, because both the grayscale of the previous row and the target grayscale of the current row have a grayscale value of 64, the overdrive grayscale of the current row, which is looked up to be obtained, still has a grayscale value of 64 and the data line does not perform hopping. However, because an average voltage of charging the R sub-pixel would be above the target voltage U1 due to influence of parasitic capacitance, the R sub-pixel would be overcharged.

Technical problem: an embodiment of the present disclosure provides a display device and an overdrive method thereof to solve the technical problem of overcharging sub-pixels of a next row incurred by a situation when a grayscale of a current row hops but a grayscale of the next row does not hop when data lines charge the pixel existing in overdrive methods in current display devices.

### SUMMARY OF INVENTION

To solve the above problem, an embodiment of the present disclosure provides technical solutions as follows:

An embodiment of the present disclosure provides an overdrive method of a display device. The method comprises following steps:

S10: providing a display panel, wherein the display panel comprises a plurality of array-distributed sub-pixels and a plurality of data lines, and the sub-pixels in each column are correspondingly connected to one of the data lines;

S20: in a frame picture, when a data signal of a data line needs to be switched from a grayscale of a previous row to a target grayscale of a current row, looking up to obtain a feedback grayscale according to a default feedback lookup table, the target grayscale of the current row, and an input grayscale of the previous row;

S30: looking up to obtain a gain grayscale according to a default gain lookup table and the feedback grayscale and storing the gain grayscale into a row buffer, wherein the gain grayscale is used as the input grayscale of the previous row when the data line performs a next switch of grayscales;

the step S10 further comprising: dividing the display panel into a plurality of compensation regions, wherein the sub-pixels in each compensation region have a same voltage compensation coefficient; and

the step S20 further comprising: looking up to obtain an overdrive grayscale according to a default overdrive lookup table, the target grayscale of the current row, and the input grayscale of the previous row, and loading an overdrive voltage corresponding to the overdrive grayscale to the data line.

In at least one embodiment of the present disclosure, acquisition of the overdrive voltage comprises:

a timing controller receiving the target grayscale of the current row from an image data source and receiving the input grayscale of the previous row from the row buffer;

looking up to obtain the overdrive grayscale by comparing the target grayscale of the current row and the input grayscale of the previous row through the overdrive lookup table;

the timing controller inputting a drive signal of the data line to a source driver; and

the source driver loading the overdrive voltage corresponding to the overdrive grayscale to the data line.

In at least one embodiment of the present disclosure, the target grayscale of the current row from the image data source is input to the timing controller and the feedback lookup table.

In at least one embodiment of the present disclosure, the input grayscale of the previous row from the row buffer is input to the timing controller and the feedback lookup table.

In at least one embodiment of the present disclosure, in the step S30, a gain factor corresponding to the feedback grayscale is matched according to a compensation region where the sub-pixels corresponding to the data line are disposed.

An embodiment of the present disclosure further provides an overdrive method of a display device. The method comprises following steps:

S10: providing a display panel, wherein the display panel comprises a plurality of array-distributed sub-pixels and a plurality of data lines, and the sub-pixels in each column are correspondingly connected to one of the data lines;

S20: in a frame picture, when a data signal of a data line needs to be switched from a grayscale of a previous row to a target grayscale of a current row, looking up to obtain a feedback grayscale according to a default feedback lookup table, the target grayscale of the current row, and an input grayscale of the previous row; and

S30: looking up to obtain a gain grayscale according to a default gain lookup table and the feedback grayscale and storing the gain grayscale into a row buffer, wherein the gain grayscale is used as the input grayscale of the previous row when the data line performs a next switch of grayscales.

In at least one embodiment of the present disclosure, the step S20 further comprises:

looking up to obtain an overdrive grayscale according to a default overdrive lookup table, the target grayscale of the current row, and the input grayscale of the previous row, and loading an overdrive voltage corresponding to the overdrive grayscale to the data line.

In at least one embodiment of the present disclosure, acquisition of the overdrive voltage comprises:

a timing controller receiving the target grayscale of the current row from an image data source and receiving the input grayscale of the previous row from the row buffer;

looking up to obtain the overdrive grayscale by comparing the target grayscale of the current row and the input grayscale of the previous row through the overdrive lookup table;

the timing controller inputting a drive signal of the data line to a source driver; and

the source driver loading the overdrive voltage corresponding to the overdrive grayscale to the data line.

In at least one embodiment of the present disclosure, the target grayscale of the current row from the image data source is input to the timing controller and the feedback lookup table.

In at least one embodiment of the present disclosure, the input grayscale of the previous row from the row buffer is input to the timing controller and the feedback lookup table.

In at least one embodiment of the present disclosure, the step S10 further comprises: dividing the display panel into a plurality of compensation regions, wherein the sub-pixels in each compensation region have a same voltage compensation coefficient; and

In at least one embodiment of the present disclosure, in the step S30, a gain factor corresponding to the feedback grayscale is matched according to a compensation region where the sub-pixels corresponding to the data line are disposed.

An embodiment of the present disclosure provides a display device which comprises a display panel, a timing controller, a row buffer connected to the timing controller, a feedback lookup table connected to the row buffer, and a gain lookup table connected to the feedback lookup table and the row buffer. Wherein the display panel comprises a plurality of array-distributed sub-pixels and a plurality of data lines, and the sub-pixels in each column are correspondingly connected to one of the data lines; the row buffer is used to store an input grayscale of a previous row and to input the input grayscale of the previous row to the timing controller and the feedback lookup table when a data signal of a data line needs to be switched from the grayscale of the previous row to a target grayscale of a current row in a frame picture; the feedback lookup table is used to read the input grayscale of the previous row and the target grayscale of the current row and to look up to obtain a feedback grayscale; and the gain lookup table is used to read the feedback grayscale and to look up to obtain a gain grayscale, and the gain grayscale is used as the input grayscale of the previous row when the data line performs a next switch of grayscales.

In at least one embodiment of the present disclosure, the display device further comprises an overdrive lookup table connected to the timing controller and a source driver connected to the timing controller and the display panel, wherein the overdrive lookup table is used to compare the target grayscale of the current row with the input grayscale of the previous row and to look up to obtain an overdrive grayscale.

In at least one embodiment of the present disclosure, the display panel further comprises a plurality of compensation regions, and the sub-pixels in each compensation region have a same voltage compensation coefficient.

In at least one embodiment of the present disclosure, the display device further comprises a gate driver connected to the timing controller and the display panel.

In at least one embodiment of the present disclosure, the display panel further comprises a plurality of scan lines connected to the source driver, and the sub-pixels on each row are correspondingly connected to a same one of the scan lines.

Beneficial effect: the present disclosure adds a feedback lookup table and a gain lookup table which makes a line overdrive technique have a feedback function, enabling actual data of drive voltages of data lines to be stored in a row buffer, thereby preventing sub-pixels of a next row from being overcharged because of the line overdrive technique and making panel charging more precisely.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic diagram of a charging curve of sub-pixels in current technology.

FIG. 2 is a schematic structural diagram of a display device according to an embodiment of the present disclosure.

FIG. 3 is a schematic structural diagram of a display panel according to an embodiment of the present disclosure.

FIG. 4 is a flowchart of an overdrive method of a display device according to an embodiment of the present disclosure.

FIG. 5 is a schematic partition diagram of a display panel according to an embodiment of the present disclosure.

FIG. 6 is a schematic diagram of a charging curve of sub-pixels according to an embodiment of the present disclosure.

FIG. 7 is a schematic diagram of a charging principle of sub-pixels of a current row according to an embodiment of the present disclosure.

FIG. 8 is a schematic diagram of a charging principle of sub-pixels of a next row according to an embodiment of the present disclosure.

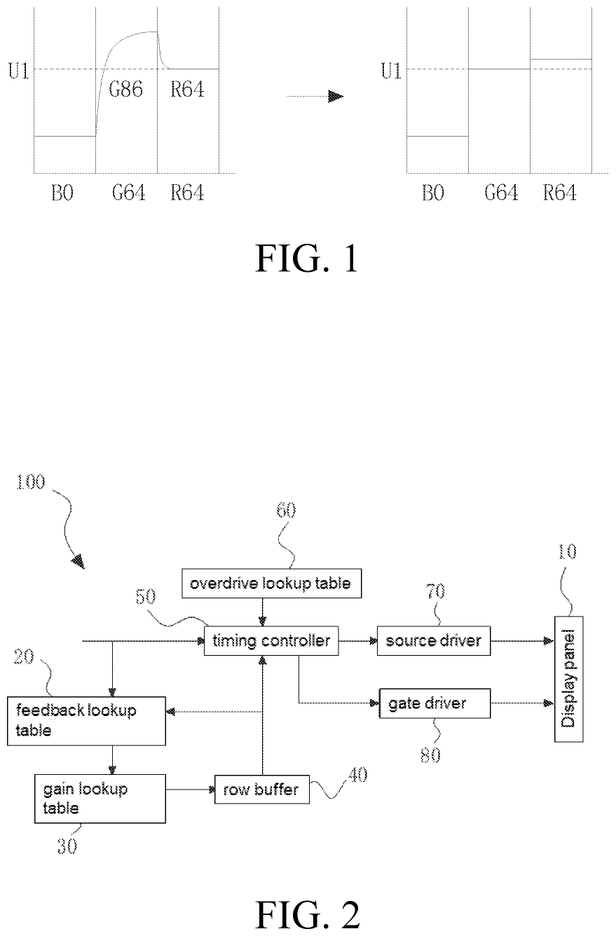

### DETAILED DESCRIPTION OF PREFERRED EMBODIMENTS

The embodiments of the present disclosure are described in detail hereinafter. Examples of the described embodiments are given in the accompanying drawings. The specific embodiments described with reference to the attached drawings are all exemplary and are intended to illustrate and interpret the present disclosure. Based on the embodiments in the present disclosure, all other embodiments obtained by those skilled in the art without creative efforts are within the scope of the present disclosure.

In the description of the present disclosure, it should be understood that terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counter-clockwise”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or implicitly indicating the number of technical features indicated. Thus, features limited by “first” and “second” are intended to indicate or imply including one or more than one these features. In the description of the present disclosure, “a plurality of” relates to two or more than two, unless otherwise specified.

In the description of the present disclosure, it should be noted that unless there are express rules and limitations, the terms such as “mount,” “connect,” and “bond” should be comprehended in broad sense. For example, it can mean a permanent connection, a detachable connection, or an integrate connection; it can mean a mechanical connection, an electrical connection, or can communicate with each other; it can mean a direct connection, an indirect connection by an intermediate, or an inner communication or an inter-reaction between two elements. A person skilled in the art should understand the specific meanings in the present disclosure according to specific situations.

In the description of the present disclosure, unless specified or limited otherwise, it should be noted that, a structure in which a first feature is “on” or “beneath” a second feature may include an embodiment in which the first feature directly contacts the second feature and may also include an embodiment in which an additional feature is formed between the first feature and the second feature so that the first feature does not directly contact the second feature. Furthermore, a first feature “on,” “above,” or “on top of” a second feature may include an embodiment in which the first feature is right “on,” “above,” or “on top of” the second feature and may also include an embodiment in which the first feature is not right “on,” “above,” or “on top of” the second feature, or just means that the first feature has a sea level elevation greater than the sea level elevation of the second feature. While first feature “beneath,” “below,” or “on bottom of” a second feature may include an embodiment in which the first feature is right “beneath,” “below,” or “on bottom of” the second feature and may also include an embodiment in which the first feature is not right “beneath,” “below,” or “on bottom of” the second feature, or just means that the first feature has a sea level elevation less than the sea level elevation of the second feature.

The following description provides many different embodiments or examples for implementing different structures of the present disclosure. In order to simplify the present disclosure, the components and settings of a specific example are described below. Of course, they are merely examples and are not intended to limit the present disclosure. In addition, the present disclosure may repeat reference numerals and/or reference letters in different examples, which are for the purpose of simplicity and clarity, and do not indicate the relationship between the various embodiments and/or arrangements discussed. In addition, the present disclosure provides examples of various specific processes and materials, but one of ordinary skill in the art will recognize the use of other processes and/or the use of other materials.

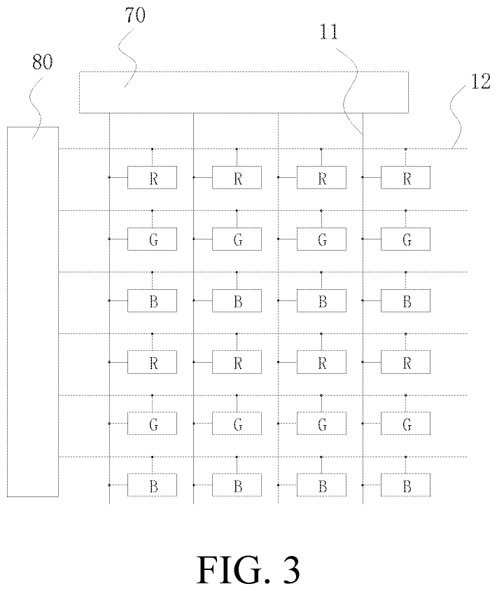

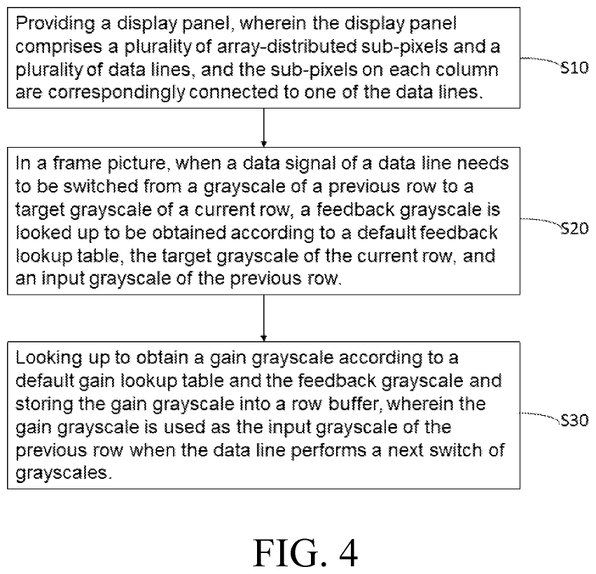

As shown from FIG. 2 to FIG. 4, an embodiment of the present disclosure provides an overdrive method of a display device 100. The method comprises following steps:

S10: providing a display panel 10, wherein the display panel 10 comprises a plurality of array-distributed sub-pixels 13 and a plurality of data lines 11, and sub-pixels 13 in each column are correspondingly connected to one of the data lines 11;

S20: in a frame picture, when a data signal of a data line 11 needs to be switched from an input grayscale of a previous row to a target grayscale of a current row, looking up to obtain a feedback grayscale according to a default feedback lookup table 20, the target grayscale of the current row, and an input grayscale of the previous row; and

S30: looking up to obtain a gain grayscale according to a default gain lookup table 30 and the feedback grayscale and storing the gain grayscale into a row buffer 40, wherein the gain grayscale is used as the input grayscale of the previous row when the data line 11 performs a next switch of grayscales.

The step S20 further comprises looking up to obtain an overdrive grayscale according to a default overdrive lookup table 60, the target grayscale of the current row, and the input grayscale of the previous row, and loading an overdrive voltage corresponding to the overdrive grayscale to the data line 11.

The display device 100 further comprises a timing controller 50 and a source driver 70 connected to the timing controller 50. The timing controller 50 transmits a drive signal to the source driver 70, and the source driver 70 loads a drive voltage to the display panel.

Specifically, the step S20 comprises first, the timing controller 50 receiving the target grayscale of the current row from an image data source and receiving the input grayscale of the previous row from the row buffer 40;

then, looking up to obtain the overdrive grayscale by comparing the target grayscale of the current row with the input grayscale of the previous row through the overdrive lookup table 60;

after that, the timing controller 50 inputting the drive signal of the data line to the source driver; and

at last, the source driver 70 loading the overdrive voltage corresponding to the overdrive grayscale to the data line 11.

In a frame picture, when a data signal of a data line needs to be switched from a grayscale of a previous row to a target grayscale of a current row, the target grayscale of the current row from an image data source is processed by two paths. One path is it inputs to the timing controller 50, and the other path is it inputs to the feedback lookup table 20. The input grayscale of the previous row from the row buffer 40 is processed by two paths. One path is it inputs to the timing controller 50, and the other path is it inputs to the feedback lookup table 20, thereby obtaining the feedback grayscale by looking up a charging state of the sub-pixels 13 of the current row in the feedback lookup table when looking up the overdrive grayscale in the overdrive lookup table 60. It ensures that an after grayscale stored in the row buffer 40 is a grayscale corresponding to the current actual drive voltage, thereby preventing an overcharging situation when charging the sub-pixels 13 of the next row.

The step S10 further comprises dividing the display panel 10 into a plurality of compensation regions, and a plurality of sub-pixels in each compensation region have a same voltage compensation coefficient.

As shown in FIG. 5, in some embodiments, the display panel 10 is divided into six compensation regions, for example, two compensation regions N+1, N−1 disposed in the middle, two compensation regions N+2 disposed at two terminals of the compensation region N+1, and two compensation regions N−2 disposed at two terminals of the compensation region N−1. Different numbered compensation regions correspond to different voltage compensation coefficients, and same numbered compensation regions correspond to same voltage compensation coefficients. Because charging situations of the sub-pixels 13 at different positions of the display panel 10 are subjected to different resistance-capacitance influences, each compensation region of the display panel 10 needs to have different compensation values to reduce or even eliminate the resistance-capacitance influences which affect the sub-pixels 13 in a corresponding compensation region thereof during charging.

In the step S30, a gain factor corresponding to the feedback grayscale is matched according to a compensation region where the sub-pixels 13 corresponding to the data line 11 are disposed.

Specifically, according to the feedback grayscale and the voltage compensation coefficient of the compensation region where the sub-pixels 13 to be charged are disposed, looking up the corresponding gain factor in the gain lookup table, then multiplying the gain factor by the feedback grayscale to obtain the gain grayscale, and storing the gain grayscale to the row buffer 40. Wherein, the gain grayscale is used as the input grayscale of the previous row to be input to the timing controller 50 when the data line 11 performs a next switch of grayscales.

The timing controller 50 is further connected to the gate driver 80 and is used to send a scan signal to the gate driver 80, and the gate driver 80 loads the scan signal to the display panel 10.

The display panel 10 further comprises a plurality of scan lines 12, and the sub-pixels 13 in each row are correspondingly connected to a same scan line 12. The gate driver 80 sends the scan signal to the scan line 12, and the scan line 12 achieves to scan the sub-pixels 13 row by row.

Further, the display panel 10 can be a tri-gate structure, which can effectively reduce a number of the data lines and a number of pins of the source driver to reduce productive costs. The plurality of sub-pixels 13 comprise different colors of first sub-pixels, second sub-pixels, and third sub-pixels. The sub-pixels 13 in a same column are arranged in a sequence of a first sub-pixel, a second sub-pixel, and a third sub-pixel, and the sub-pixels 13 in a same row have a same color. Other embodiments can have other arrangements of sub-pixels, which is not limited herein.

In the embodiment, the first sub-pixels, the second sub-pixels, and the third sub-pixels are blue (B) sub-pixels, green (G) sub-pixels, and red (R) sub-pixels, respectively.

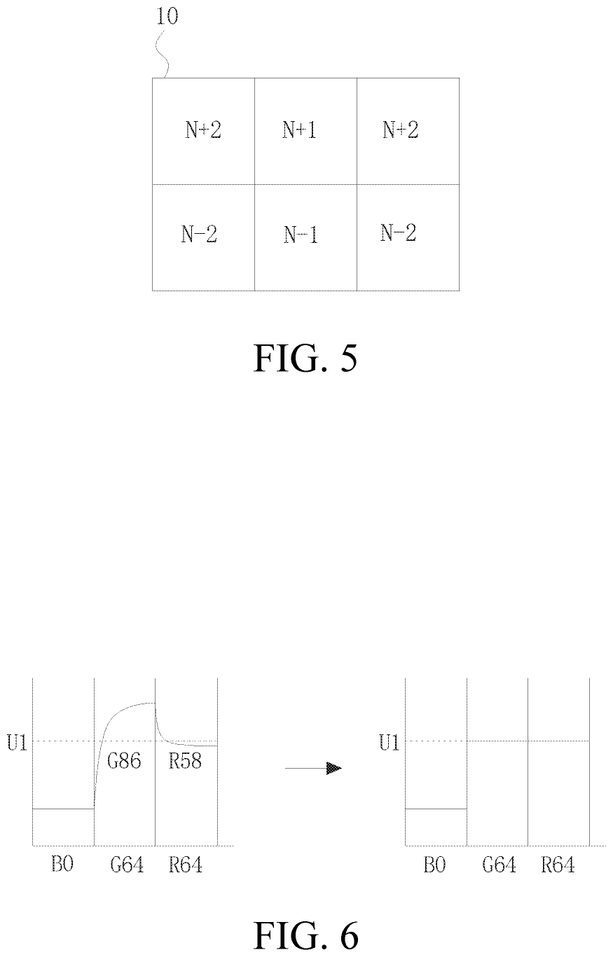

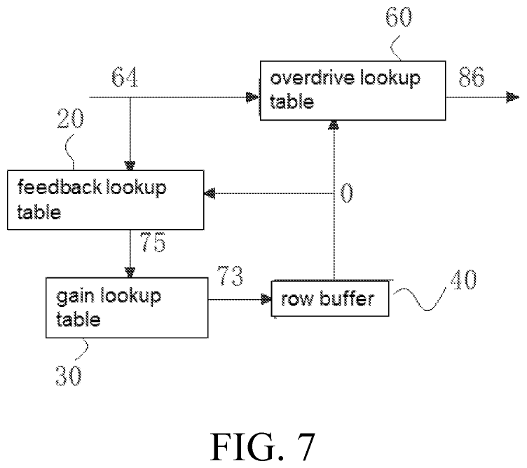

For example, as shown in FIG. 6 and FIG. 7, a data line 11 in the second column has a grayscale value of 64 when charging a G sub-pixel at the second column and the second row, that is, the target grayscale of the current row has a grayscale value of 64, and the data line 11 has a grayscale value of 0 when charging the sub-pixels of the previous row (that is a B sub-pixel at the second column and the first row), that is, the input grayscale of the previous row has a grayscale value of 0. On one hand, the overdrive grayscale having a grayscale value of 86 is obtained by looking it up in the overdrive lookup table 60, and the data line 11 loads a drive voltage corresponding to the grayscale value of 86 to make an average voltage of the data line 11 charging the G sub-pixel be a target voltage U1. On the other hand, the target grayscale of the current row is subjected to a feedback processing, that is, the feedback grayscale having a grayscale value of 75 is obtained by looking it up in the feedback lookup table 20, then the gain grayscale having a grayscale value of 75 is obtained by a partition searching in the gain lookup table 30, and then the grayscale value of 75 is stored to the row buffer 40 and used as a data of the input grayscale of the previous row when the data line 11 performs a next switch of grayscales.

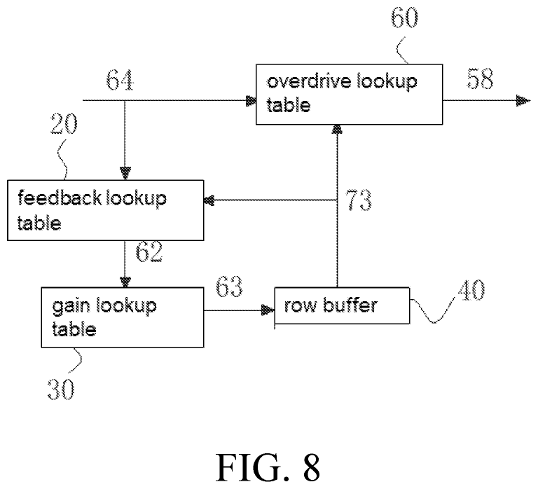

As shown in FIG. 6 and FIG. 8, when the scan line 12 continues to scan the third row, the data line 11 has a grayscale value of 64 when charging a R sub-pixel at the second column and the third row, that is, the target grayscale of the current row has a grayscale value of 64, and the input grayscale of the previous row has a grayscale value of 73. On one hand, the overdrive grayscale having a grayscale value of 58 is obtained by looking it up in the overdrive lookup table 60, and the data line 11 loads a drive voltage corresponding to the grayscale value of 58 to make the average voltage of the data line 11 charging the R sub-pixel be the target voltage U1, thereby preventing overcharge. On the other hand, the target grayscale of the current row is subjected to a feedback processing, that is, the feedback grayscale having a grayscale value of 62 is obtained by looking it up in the feedback lookup table 20, then the gain grayscale having a grayscale value of 63 is obtained by a partition searching in the gain lookup table 30, and then the grayscale value of 63 is stored to the row buffer 40 and used as a data of the input grayscale of the previous row when the data line 11 performs a next switch of grayscales.

It can be known from FIG. 6, the present disclosure adds a feedback lookup table and a gain lookup table to make a grayscale stored in a row buffer be a grayscale corresponding to an actual voltage, which can solve the problem of overcharging sub-pixels of a next row incurred by a situation when a grayscale of a current row hops but a grayscale of a next row does not hop when data lines charge the pixel.

An embodiment of the present disclosure further provides a display device 100 which comprises a display panel 10, a timing controller 50, a row buffer 40 connected to the timing controller 50, a feedback lookup table 20 connected to the row buffer 40, and a gain lookup table 30 connected to the feedback lookup table 20 and the row buffer 40.

The display panel 10 comprises a plurality of array-distributed sub-pixels 13 and a plurality of data lines 11, and the sub-pixels 13 in each column are correspondingly connected to one of the data lines 11.

The row buffer 40 is used to store an input grayscale of a previous row and to input the input grayscale of the previous row to the timing controller 50 and the feedback lookup table 20 when a data signal of a data line 11 needs to be switched from the grayscale of the previous row to a target grayscale of a current row in a frame picture.

The feedback lookup table 20 is used to read the input grayscale of the previous row and the target grayscale of the current row and to look up to obtain a feedback grayscale.

The gain lookup table 30 is used to read the feedback grayscale and to look up to obtain a gain grayscale, and the gain grayscale is used as the input grayscale of the previous row when the data line 11 performs a next switch of grayscales.

The display panel 10 further comprises a plurality of scan lines connected to the source driver, and the sub-pixels in each row are correspondingly connected to a same one of the scan lines.

The display device 100 further comprises an overdrive lookup table 60 connected to the timing controller 50, a source driver 70 connected to the timing controller 50 and the display panel 10, and a gate driver 80 connected to the timing controller 50. The display panel 10 further comprises a plurality of scan lines 12 connected to the source driver 70. The sub-pixels 13 in each row are correspondingly connected to a same one of the scan lines 12, and the gate driver 80 is connected to the display panel 10. The overdrive lookup table 60 is used to compare the target grayscale of the current row with the input grayscale of the previous row and to look up to obtain an overdrive grayscale.

The display panel 10 further comprises a plurality of compensation regions, and the sub-pixels in each compensation region have a same voltage compensation coefficient.

Further, the display panel 10 can be a tri-gate structure, which can effectively reduce a number of the data lines and a number of pins of the source driver to reduce productive costs. The plurality of sub-pixels 13 comprise different colors of first sub-pixels, second sub-pixels, and third sub-pixels. The sub-pixels 13 in a same column are arranged in a sequence of a first sub-pixel, a second sub-pixel, and a third sub-pixel, and the sub-pixels 13 in a same row have a same color. Other embodiments can have other arrangements of sub-pixels, which is not limited herein.

In the embodiment, the first sub-pixels, the second sub-pixels, and the third sub-pixels are blue (B) sub-pixels, green (G) sub-pixels, and red (R) sub-pixels, respectively.

As shown in FIG. 5, in some embodiments, the display panel 10 is divided into six compensation regions, for example, two compensation regions N+1, N−1 disposed in the middle, two compensation regions N+2 disposed at two terminals of the compensation region N+1, and two compensation regions N−2 disposed at two terminals of the compensation region N−1. Different numbered compensation regions correspond to different voltage compensation coefficients, and same numbered compensation regions correspond to same voltage compensation coefficients. Because charging situations of the sub-pixels 13 at different positions of the display panel 10 are subjected to different resistance-capacitance influences, each compensation region of the display panel 10 needs to have different compensation values to reduce or even eliminate the resistance-capacitance influences which affect the sub-pixels 13 in a corresponding compensation region thereof during charging.

A working process of the display device 100 in the present disclosure comprises: in a frame picture, when a data signal of a data line 11 needs to be switched from a grayscale of a previous row to a target grayscale of a current row, on one hand, looking up to obtain a feedback grayscale according to a default feedback lookup table 20, the target grayscale of the current row, and an input grayscale of the previous row, and on the other hand, an overdrive grayscale is looked up to be obtained according to a default overdrive lookup table, the target grayscale of the current row, and the input grayscale of the previous row, and an overdrive voltage corresponding to the overdrive grayscale is loaded to the data line; and then, a gain grayscale is looked up to be obtained according to a default gain lookup table 30 and the feedback grayscale, and the gain grayscale is stored into a row buffer 40, wherein the gain grayscale is used as the input grayscale of the previous row when the data line 11 performs a next switch of grayscales.

The specific working process of the display device 100 can refer to the above overdrive method, which is not repeated herein.

The present disclosure adds a feedback lookup table and a gain lookup table, which makes a line overdrive technique have a feedback function, enabling actual data of drive voltages of data lines to be stored in a row buffer, thereby preventing sub-pixels of a next row from being overcharged because of the line overdrive technique and making panel charging more precisely.

In the above embodiments, the description of each embodiment has its own emphasis. For the parts that are not described in detail in an embodiment, can refer to the detailed description of other embodiments above.

The display device and the overdrive method thereof provided by the present disclosure are described in detail above. The specific examples are applied in the description to explain the principle and implementation of the disclosure. The description of the above embodiments is only for helping to understand the technical solution of the present disclosure and its core ideas, and it is understood that many changes and modifications to the described embodiment can be carried out without departing from the scope and the spirit of the disclosure that is intended to be limited only by the appended claims.

What is claimed is:

1. An overdrive method of a display device, comprising following steps:
S10: providing a display panel, wherein the display panel comprises a plurality of array-distributed sub-pixels and a plurality of data lines, and the sub-pixels in each column are correspondingly connected to one of the data lines;
S20: in a frame picture, when a data signal of a data line needs to be switched from a grayscale of a previous row to a target grayscale of a current row, looking up to obtain a feedback grayscale according to a default feedback lookup table, the target grayscale of the current row, and an input grayscale of the previous row;
S30: looking up to obtain a gain grayscale according to a default gain lookup table and the feedback grayscale and storing the gain grayscale into a row buffer, wherein the gain grayscale is used as the input grayscale of the previous row when the data line performs a next switch of grayscales;
the step S10 further comprising dividing the display panel into a plurality of compensation regions, wherein a plurality of sub-pixels in each compensation region have a same voltage compensation coefficient; and
the step S20 further comprising looking up to obtain an overdrive grayscale according to a default overdrive lookup table, the target grayscale of the current row, and the input grayscale of the previous row, and loading an overdrive voltage corresponding to the overdrive grayscale to the data line.

2. The overdrive method according to claim 1, wherein acquisition of the overdrive voltage comprises:
a timing controller receiving the target grayscale of the current row from an image data source and receiving the input grayscale of the previous row from the row buffer;
looking up to obtain the overdrive grayscale by comparing the target grayscale of the current row with the input grayscale of the previous row through the overdrive lookup table;
the timing controller inputting a drive signal of the data line to a source driver; and
the source driver loading the overdrive voltage corresponding to the overdrive grayscale to the data line.

3. The overdrive method according to claim 2, wherein the target grayscale of the current row from the image data source is input to the timing controller and the feedback lookup table.

4. The overdrive method according to claim 2, wherein the input grayscale of the previous row from the row buffer is input to the timing controller and the feedback lookup table.

5. The overdrive method according to claim 1, wherein in the step S30, a gain factor corresponding to the feedback grayscale is matched according to a compensation region where the sub-pixels corresponding to the data line are disposed.

6. An overdrive method of a display device, comprising following steps:
S10: providing a display panel, wherein the display panel comprises a plurality of array-distributed sub-pixels and a plurality of data lines, and the sub-pixels in each column are correspondingly connected to one of the data lines;
S20: in a frame picture, when a data signal of a data line needs to be switched from a grayscale of a previous row to a target grayscale of a current row, looking up to obtain a feedback grayscale according to a default feedback lookup table, the target grayscale of the current row, and an input grayscale of the previous row; and
S30: looking up to obtain a gain grayscale according to a default gain lookup table and the feedback grayscale and storing the gain grayscale into a row buffer, wherein the gain grayscale is used as the input grayscale of the previous row when the data line performs a next switch of grayscales.

7. The overdrive method according to claim 6, wherein the step S20 comprises:
looking up to obtain an overdrive grayscale according to a default overdrive lookup table, the target grayscale of the current row, and the input grayscale of the previous row, and loading an overdrive voltage corresponding to the overdrive grayscale to the data line.

8. The overdrive method according to claim 7, wherein acquisition of the overdrive voltage comprises:
a timing controller receiving the target grayscale of the current row from an image data source and receiving the input grayscale of the previous row from the row buffer;
looking up to obtain the overdrive grayscale by comparing the target grayscale of the current row with the input grayscale of the previous row through the overdrive lookup table;
the timing controller inputting a drive signal of the data line to a source driver; and
the source driver loading the overdrive voltage corresponding to the overdrive grayscale to the data line.

9. The overdrive method according to claim 8, wherein the target grayscale of the current row from the image data source is input to the timing controller and the feedback lookup table.

10. The overdrive method according to claim 8, wherein the input grayscale of the previous row from the row buffer is input to the timing controller and the feedback lookup table.

11. The overdrive method according to claim 6, wherein the step S10 further comprises dividing the display panel into a plurality of compensation regions, wherein a plurality of sub-pixels in each compensation region have a same voltage compensation coefficient.

12. The overdrive method according to claim 11, wherein in the step S30, a gain factor corresponding to the feedback grayscale is matched according to a compensation region where the sub-pixels corresponding to the data line are disposed.

13. A display device, comprising:
a display panel, a timing controller, a row buffer connected to the timing controller, a feedback lookup table connected to the row buffer, and a gain lookup table connected to the feedback lookup table and the row buffer;
wherein the display panel comprises a plurality of array-distributed sub-pixels and a plurality of data lines, and the sub-pixels in each column are correspondingly connected to one of the data lines;
the row buffer is used to store an input grayscale of a previous row and to input the input grayscale of the previous row to the timing controller and the feedback lookup table when a data signal of a data line needs to be switched from the grayscale of the previous row to a target grayscale of a current row in a frame picture;
the feedback lookup table is used to read the input grayscale of the previous row and the target grayscale of the current row and to look up to obtain a feedback grayscale; and
the gain lookup table is used to read the feedback grayscale and to look up to obtain a gain grayscale, and the gain grayscale is used as the input grayscale of the previous row when the data line performs a next switch of grayscales.

14. The display device according to claim 13, comprising an overdrive lookup table connected to the timing controller and a source driver connected to the timing controller and the display panel, wherein the overdrive lookup table is used to compare the target grayscale of the current row with the input grayscale of the previous row and to look up to obtain an overdrive grayscale.

15. The display device according to claim 13, wherein the display panel further comprises a plurality of compensation regions, and a plurality of sub-pixels in each compensation region have a same voltage compensation coefficient.

16. The display device according to claim 13, comprising a gate driver connected to the timing controller and the display panel.

17. The display device according to claim 16, wherein the display panel comprises a plurality of scan lines connected to a source driver, and the sub-pixels in each row are correspondingly connected to a same one of the scan lines.
